(19) United States
(12) Patent Application Publication
(10) Pub. No.: US 2009/0220927 A1
(43) Pub. Date: Sep. 3, 2009

(54) ARTICULATOR

(75) Inventor: Jürgen Amann, Koblach (AT)

Correspondence Address: GIBSON & DERNIER L.L.P., 900 ROUTE 9 NORTH, SUITE 504, WOODBRIDGE, NJ, 07095, US

(73) Assignee: AMANN GIRRBACH GMBH, Koblach (AT)

(21) Appl. No.: 11/910,950

(22) PCT Filed: Apr. 11, 2006
(86) PCT No.: PCT/IB2006/051109

§ 371 Date: Feb. 12, 2008

(30) Foreign Application Priority Data
Apr. 11, 2005 (DE) 102005016741.1

(51) Int. Cl. G09B 23/28

(52) U.S. Cl. 434/264

(57) ABSTRACT

An articulator has, between a flat upper part (having an anterior guide pin insertable at the front end) and a flat lower part approximately parallel thereto, supports which have an upper end which supports the upper part and which can be supported with a contact surface in the region of a lower end on a substrate. At least a part of the supports consists of a carbon material.

### BACKGROUND

The invention relates to an articulator comprising supports extending between a flat upper part having an anterior guide pin insertable at the front end and a flat lower part approximately parallel thereto, which supports have an upper end which supports the upper part and can be supported with a contact surface in the region of a lower end on a substrate.

Articulators of this type are on the market and have generally also proved satisfactory. As is known, an articulator is a movement simulator or model for simulating the chewing and closing movement of the human jaw in order to be able to replicate the rows of teeth of the upper jaw and of the lower jaw. This of course requires that the articulator can be brought into different positions and set up, i.e. for example with the top lowermost and vice versa, or in a certain angular position (e.g. 45°), in order to have better access to the front end. All in all, when using an articulator, a very great deal of handling thereof occurs. There is therefore a further desire that the articulator be relatively rigid and stable in order to maintain the settings and dimensions found and to give as precise a result as possible.

### SUMMARY OF THE INVENTION

It is the object of the invention to facilitate the handling, and this is done, according to the invention, by virtue of the fact that at least a part of the supports consist of a carbon material. It has been found that only such a material—apart from the metal used to date—is firstly capable of meeting the abovementioned desire and secondly facilitates the handling during setup thereof in various positions by a substantial reduction in the weight of the articulator. In addition, this choice in material also makes it possible to dispense with a coating (possibly apart from a clear coat), which leads to lower costs.

Particularly simple handling results if, according to a preferred embodiment of the invention, the supports have a first support section running substantially along the lower part and having a first contact surface and a second support surface extending at an angle thereto differing from 90° away from the front end and having a second contact surface which makes an angle with the first contact surface and adjacent to which is a bearing section for the upper part. This unusual form permits a more stable setup of the articulator at an angle and also facilitates this in that it is now no longer necessary to secure this angle, for example, by mounting or removing support pins or other support geometries, as in the prior art, in which case a further, more stable contact surface is created simply in this manner. This is particularly advantageous with the use of carbon material, but this form does of course also have an advantage with the use of metal and therefore represents an invention independent of the material used.

A problem in the case of articulators is that, for example, a casting of the teeth of a jaw, such as of the lower jaw, has to be removed again and again, during which manipulation the surface of the articulator may even be damaged. This is of course particularly delicate with the use of carbon material. According to the invention, it is therefore preferable if a base plate is detachably fixed, for example adjustably, e.g. screwed, on the upper part and/or on the lower part, preferably on the first support section, on which base plate a jaw plate, in particular a lower jaw plate, is detachably fixed. This permits easier handling and—in spite of the advantages particularly in the case of carbon material—is also not necessarily limited thereto but represents a further concept of the invention which is independent per se.

It has already been mentioned above that the dimensional accuracy and dimensional stability which is associated with the rigidity and strength of the construction of an articulator is of particular importance for the articulator. It is therefore preferable to choose and to use the carbon material so that at least one of the rigidity and strength requirements is met in combination with a weight which is reduced compared with the prior art.

In the handling, inter alia the insertion and setting up of the support pin plays a role. Here too, the handling can be improved if the upper part has, on an adjusting screw for the support pin, a rubber disk as a holder through which said support pin can pass. In this way, the adjustment can be effected by means of the adjusting screw, whereas the support pin need only be pushed into a central hole of the rubber disk. Here too, it is evident that this embodiment would also have advantages if no carbon material were to be used, and it is for this reason that this construction constitutes a separate invention per se.

A sort of self centering of the anterior guide pin results if the lower part has an anterior guide table with an approximately funnel-like depression opposite the anterior guide pin. This can be particularly easily realized in a development according to the invention with the use of carbon material, but this embodiment could also be used in the case of embodiments in conventional metal. This concept of the invention, too, is therefore independent per se of the use of carbon material.

If the upper part and/or the lower part is bent with its edges outward or toward the respective substrate this results firstly in anatomically favorable access in this region, and secondly these edges can also be formed as a contact surface. It should be pointed out that this is a further concept of the invention which is closely associated with the design of the lower part and of the support from carbon material but on the other hand would also be capable of use in the case of supports of conventional type and shape.

### BRIEF DESCRIPTION OF THE DRAWINGS

Further details of the invention are evident from the following description of working examples shown schematically in the drawings, without wishing to restrict the invention to the embodiments shown here.

FIG. 1 shows a perspective view of an articulator according to the invention.

FIG. 2 shows a slightly modified working example of an embodiment of an articulator in a partial side view.

FIG. 3 shows a section along the line III-III of FIG. 2.

FIG. 4 shows a section along the line IV-IV of FIG. 2.

FIG. 5 shows a section of an articulator along the line V-V of FIG. 2.

### DETAILED DESCRIPTION OF THE EMBODIMENTS OF THE INVENTION

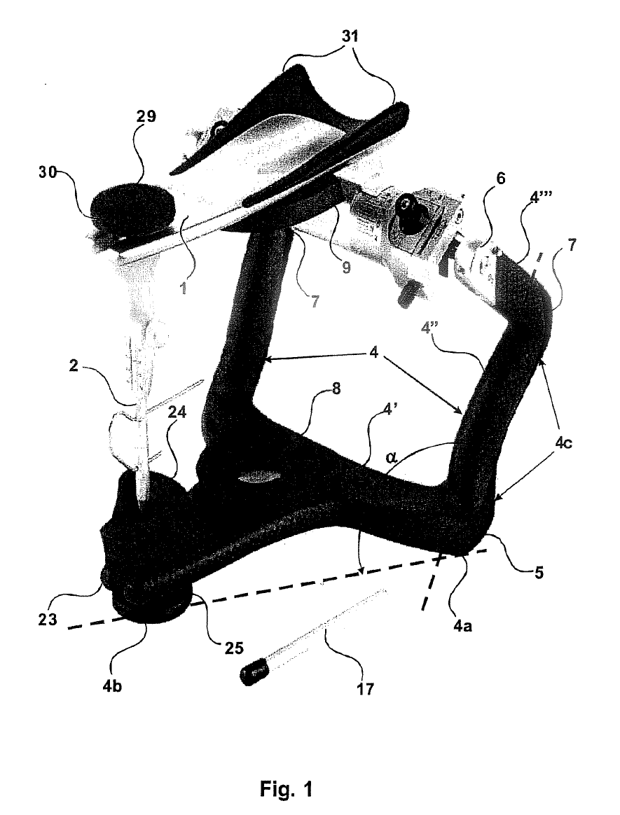

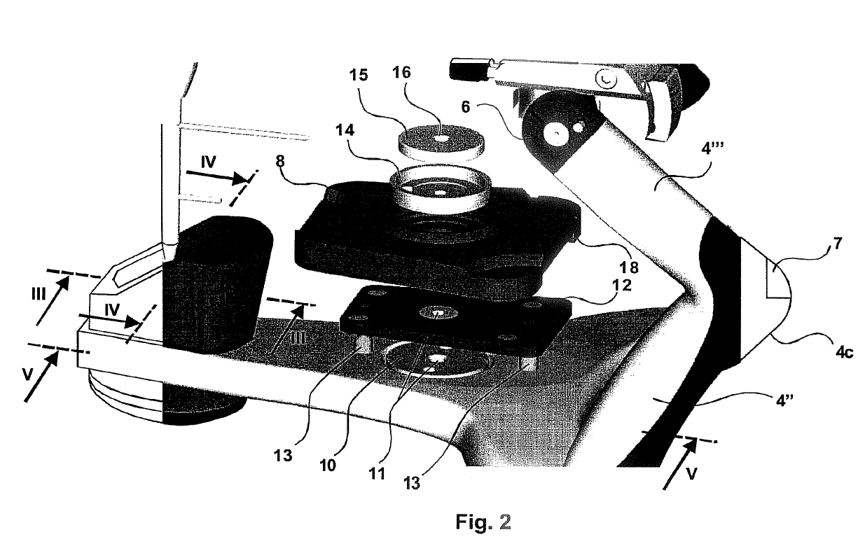

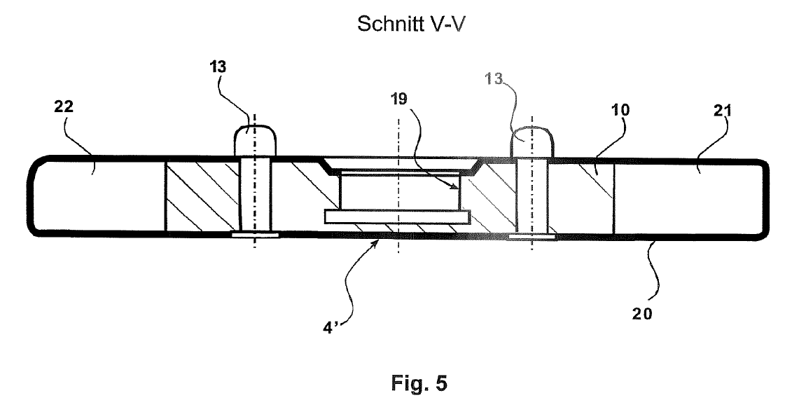

FIG. 1 shows an articulator comprising a substantially flat upper part 1 having an anterior guide pin 2 insertable at its front end and a flat lower part 3 approximately parallel to the upper part 1. Supports 4 which in the prior art are formed vertically approximately in a column-like manner extend between upper part 1 and lower part 3. In contrast to this prior art, the supports 4 have a first support section 4′ running substantially along the lower part 3 and having a first contact surface 4a, 4b and a second support section 4″ extending at an angle α thereto differing from 90° away from the front end with the anterior guide pin 2 and having a second contact surface 4c which makes an angle with the first contact surface 4a, 4b and adjacent to which is a bearing section 4′″ for the upper part 1. As indicated by particular shading (omitted in FIG. 2), all these parts 3 and 4 are produced from a carbon material, as described in detail with reference to FIG. 5. When only the supports 4 are discussed below, the totality of the formation comprising lower part 3 and supports 4 is however also meant. However, an embodiment which provides a lower part 3 of metal and actually only the supports 4 of carbon material would also be conceivable. This carbon material advantageously satisfies at least one of the following conditions:

1. The supports 4 have, in the region of their ends, a rigidity such that a flexural deflection from about 0.10 to about 0.45 mm results in the case of a load of about 50 N in the region of the respective end (as mentioned, the rigidity is a particularly important criterion).

2. The supports 4 have, in the region of the upper end supporting the upper part, a section 6 (FIG. 1) or 6′ (FIG. 2) which is adjacent to the carbon material, e.g. pressed into and/or bonded in the carbon material, and comprising a metal, preferably a light metal, such as aluminum, which improves the condylar positioning. FIG. 1 shows an embodiment having an oblique connecting surface to the carbon material, whereas FIG. 2 illustrates a straight connection.

3. The supports 4 have a flexural strength in the 0° fiber direction of ≧about 1.5 kN/mm².

4. The supports 4 have a flexural modulus in the 0° fiber direction of ≧about 80 kN/mm².

5. The supports 4 have an ILS in the 0° fiber direction of ≧about 75 N/mm².

6. The supports 4 have a tensile strength in the 0° fiber direction of ≧about 1.3 kN/mm².

7. The supports 4 have a tensile modulus in the 0° fiber direction of ≧about 100 kN/mm².

8. The supports 4 have a peel strength of ≧about 0.75 N/mm.

Of course, the function is best ensured if at least the majority of these eight conditions, but preferably all eight are fulfilled.

The angle α can be arbitrarily chosen per se. The angle α can be at least one of, but not limited to: (i) greater than about 90°; (ii) greater than about 90° to about 270°; (iii) greater than about 90° to about 135°; and (iv) about 135°. In general, however it will be about 135°, so that the articulator can be inclined practically by about 45°, giving better access to the front. The contact surface 4c is formed by bulges of a molded-on or inserted rubber part 5 (or two rubber parts provided on each bend), so that contact points a distance apart ensure a stable position of the articulator.

In order to define the occlusal plane, it is expedient to provide a mark on the supports 4. This is advantageously realized in the form of a notch 7 in the region of the transition from the second support section 4″ to the bearing section 4′″, preferably at the beginning of the latter, and particularly on the side facing away from the first contact surface 4a, 4b.

While the supports 4 were in the form of columns in the prior art, it is preferable according to the invention if the first support section 4′ itself at least partly forms the lower part 3, as shown in FIGS. 1 and 2.

It has already been stated above that the support body 4 can be exposed to considerable stresses during the handling of the articulator. It is therefore preferable if the lower jaw plate 8 (and optionally alternatively or additionally the upper jaw plate 9) is formed in the manner described with reference to FIG. 2.

The parts bearing the lower jaw plate 8 are shown as an exploded diagram in FIG. 2. Firstly, a metal mount 10 is housed in the first support section 4′, expediently integrally (also see FIG. 5). A base plate 12 is screwed onto this metal mount 10 via axially corresponding bores 11 in such a way that said base plate is preferably a distance away from the first support section 4′ which is determined by pressed-in steel bolts 13. A lower jaw plate 8 can now be displaceably and adjustably mounted on this base plate 12. The adjustment is effected in a known manner by a detachable joint, e.g. adhesion. To permit centering without problems, the lower jaw plate 8 (and/or the upper jaw plate 9) is provided with lateral guide edges 18 pointing downward toward the base plate 12.

According to a particularly preferred embodiment (FIG. 5) the metal mount 10 is present in a frame 19, for example a metallic one, and is held therein by an interlocking connection. The metal frame 19 is inserted and secured by the above-mentioned pressed-in steel pins 13 in the first support section 4′ surrounded by a carbonate shell 20. The other spaces 21 and 22 can be theoretically empty but are preferably filled with foam material. It is evident in particular from FIG. 1 that the front end of the first support section 4′ is equipped with two fork prongs, in whose longitudinal slot bounded in this manner an anterior guide table 24 is inserted and is fixed by means of a screw 25 simultaneously forming a foot and the contact surface 4b, in order to cooperate with the anterior guide pin 2. It is clear that other methods of fixing for the metal frame 10, such as adhesive bonding, embedding, baking in, or other methods known to those skilled in the art, are also possible.

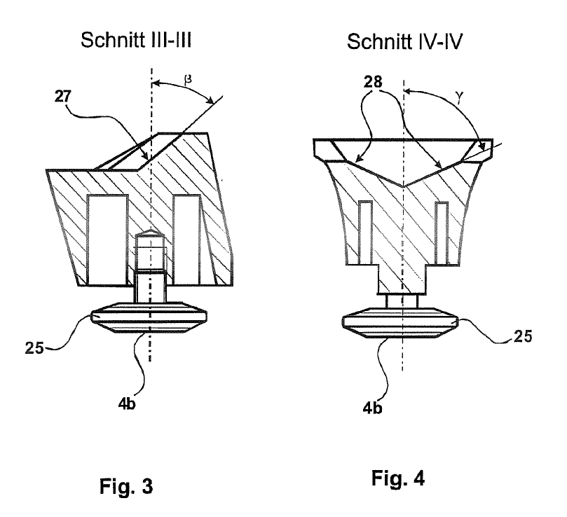

As is evident particularly from FIGS. 2 to 4, the anterior guide table 24 is approximately funnel-shaped in its interior, in order thereby to provide a sort of self-centering for table 24 and anterior guide pin 2. The section of FIG. 3 particularly clearly shows the shape of the sagittal plane 27 at a relatively steep angle β, whereas the section according to FIG. 4 shows the much flatter angle γ (larger relative to the vertical) of the plane 28 in the transverse direction.

The handling is simplified if the support pin 17 (FIG. 1) is inserted into a rubber disk 29 so that inconvenient screwing in is dispensed with. This rubber disk 29 can be inserted in an adjusting screw 30 which surrounds it as a mount or can be fixed to the top of the screw 30, for example by adhesive bonding.

A further particular feature of the embodiments shown, but not limited to, (FIG. 1) is the upward curvature of the upper part 1, which firstly permits better access and secondly creates further contact surfaces 31 (for positioning upside down) with the edges of the shell thus formed. On this contact surface 31, in cooperation with the rubber disk 29, the articulator can stand in the reverse position as a whole. The further contact surfaces 31 are preferably—as shown —also provided with rubber-elastic material.

Furthermore, an integral formation of the lower part 3 and of the supports 4 has been achieved by the use of carbon.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### LIST OF REFERENCE NUMERALS

1—Upper part
2—Anterior guide pin
3—Lower part
4—Supports
4′, 4″, 4′″—Support or bearing section
4a-4c—Contact surface
5—Rubber part
6—Section
7—Notch
8—Lower jaw plate/plate
9—Upper jaw plate
10—Metal mount/metal frame
11—Bores
12—Base plate
13—Steel bolt/steel pin
14—Centering disk
15—Centering disk
16—Centering hole
17—Support pin
18—Guide edge
19—Frame/metal frame
20—Carbonate shell
21 —Spaces
22—Spaces
24—Anterior guide table/table
25—Screw
27—Sagittal plane
28—Plane
29—Rubber disk
30 —Adjusting screw/screw
31—Contact surface

1. An articulator comprising:
supports, wherein the supports extend between an upper part having an anterior guide pin insertable at a front end and a lower part approximately parallel thereto, wherein the supports have an upper end which supports the upper part, wherein the supports can be supported with a contact surface in a region of a lower end on a substrate, and wherein at least a part of the supports consists of a carbon material.

2. The articulator of claim 1, wherein the supports have a first support section running substantially along the lower part and having a first contact surface and a second support section extending at an angle thereto differing from substantially 90° away from the front end and having a second contact surface which makes an angle with the first contact surface and to which a bearing section for the upper part is adjacent.

3. The articulator of claim 2, wherein the deviating angle is at least one of: (i) greater than about 90°; (ii) greater than about 90° to about 270°; (iii) greater than about 90° to about 135°; and (iv) about 135°.

4. The articulator of claim 2, wherein the second contact surface is in each case rubber-elastic and formed at the end of the second support section.

5. The articulator of claim 2, wherein a mark for the occlusal plane is provided, in particular on the side opposite the first contact surface, in the region of the transition from the second support section to the bearing section, preferably at the beginning of the latter.

6. The articulator of claim 2, wherein the first support section itself at least partly forms the lower part.

7. The articulator of claim 1, wherein a base plate is detachably and/or adjustably fixed on the upper part and/or on the lower part, and/or on the first support section, wherein the base plate is also adapted to be detachably fixed to a jaw plate, and/or a lower jaw plate.

8. The articulator of claim 7, wherein a metal mount for the base plate is integrated into the first support section consisting of carbon material.

9. The articulator of claim 8, wherein the metal mount is present in a frame which is inserted into the first support section and is fixed on the first support section, preferably by means of bolts.

10. The articulator of claim 1, wherein the supports have, in the region of the ends, a rigidity such that a flexural deflection of about 0.10 to about 0.45 mm results in the case of the load of about 50 N in the region of the respective end.

11. The articulator of claim 1, wherein the supports have, in the region of the upper end, supporting the upper part, a section connecting to the carbon material, wherein the section is pressed and/or adhesively bonded in the carbon material, and wherein the section is comprising at least one of: a metal, and/or a light metal, and/or aluminum.

12. The articulator of claim 1, wherein the supports have a flexural strength in the 0° fiber direction of ≧about 1.5 kN/mm².

13. The articulator of claim 1, wherein the supports have a flexural modulus in the 0° fiber direction of ≧about 80 kN/mm².

14. The articulator of claim 1, wherein the supports have an ILS in the 0° fiber direction of ≧about 75 N/mm².

15. The articulator of claim 1, wherein the supports have a tensile strength in the 0° fiber direction of ≧about 1.3 kN/mm².

16. The articulator of claim 1, wherein the supports have a tensile modulus in the 0° fiber direction of ≧about 100 kN/mm².

17. The articulator of claim 1, wherein the supports have a peel strength of ≧about 0.75 N/mm.

18. The articulator of claim 1, wherein the upper part has, on an adjusting screw for a support pin, a rubber disk as a holder through which said support pin can pass.

19. The articulator of claim 1, wherein the lower part has a guide table, wherein the guide table has an approximately funnel-like depression opposite the guide pin.

20. The articulator of claim 19, wherein the funnel-like depression has a sagittal angle to a vertical plane, wherein the sagittal angle is steeper than a transverse angle.

21. The articulator of claim 1, wherein edges of the upper part and/or the lower part are bent outward or toward the respective substrate.

22. The articulator of claim 21, wherein the upper part has, on the bent outward edges, a third contact surface, preferably having a rubber-elastic insert.

23. The articulator of claim 1, wherein the lower part and the supports are made through integral formation.

24. The integral formation of claim 23, wherein carbon is used to form the lower part and the supports integrally.
